(19) United States
(12) Patent Application Publication
(10) Pub. No.: US 2025/0334338 A1
(43) Pub. Date: Oct. 30, 2025

(54) SINTERING SYSTEM

(71) Applicants: TINCI MATERIALS (TAIZHOU) CO., LTD., Taizhou, (CN); GUANGZHOU TINCI MATERIALS TECHNOLOGY CO., LTD., Guangzhou, (CN)

(72) Inventors: Chao LIU, Taizhou, (CN); Haishen SONG, Taizhou, (CN); Jinyong WU, Taizhou, (CN); Litao SHI, Taizhou, (CN)

(21) Appl. No.: 19/216,767

(22) Filed: May 23, 2025

Related U.S. Application Data
(63) Continuation of application No. PCT/CN2024/100455, filed on Jun. 20, 2024.

(30) Foreign Application Priority Data
Apr. 29, 2024 (CN) 202410531975.0
Apr. 29, 2024 (CN) 202420924373.7

(51) Int. Cl. F27D 17/22; B01D 47/06; F27B 7/20

(52) U.S. Cl. CPC F27D 17/22; B01D 47/06; F27B 7/20

(57) ABSTRACT

The present disclosure discloses a sintering system. The sintering system includes: a rotary sintering furnace having an exhaust opening configured to discharge exhaust gas; and an exhaust gas treatment system connected to the exhaust opening and configured to treat the exhaust gas discharged from the rotary sintering furnace. The exhaust gas treatment system includes multi-stage treatment devices connected in series. At least one stage of the multi-stage treatment devices is a dust separation device. The dust separation device is configured to separate dust from the exhaust gas. At least one stage of the multi-stage treatment devices is a spray tower. The spray tower is disposed downstream of the dust separation device and configured to wash the exhaust gas that has been treated by the dust separation device.

### CROSS-REFERENCES TO RELATED APPLICATIONS

The present application is a continuation of International Application No. PCT/CN2024/100455, filed on Jun. 20, 2024, which claims the priority of the Chinese patent application No. “202410531975.0” and Chinese patent application No. “202420924373.7”, that are both filed on Apr. 29, 2024 by TINCI MATERIALS (TAIZHOU) CO., LTD. and GUANGZHOU TINCI MATERIALS TECHNOLOGY CO., LTD., all of which are hereby incorporated by reference in their entireties.

### FIELD

The present disclosure relates to the field of sintering technologies, and more specifically, to a sintering system.

### BACKGROUND

A sintering process of lithium iron phosphate needs to be performed in a protection gas atmosphere, requiring continuous introduction of a protection gas into a rotary furnace device. Therefore, the rotary furnace device needs to be provided with a gas introduction structure and an exhaust mechanism. However, exhaust gas discharged through an exhaust structure needs to be purified. Otherwise, the exhaust gas easily causes significant environmental harm.

### SUMMARY

The present disclosure aims to at least solve one of the technical problems existing in the prior art. To this end, an embodiment of the present disclosure is to provide a sintering system which is capable of introducing a protection gas to a rotary sintering furnace and discharging exhaust gas, performing an efficient purification treatment on the exhaust gas, and thus reducing the harm of exhaust gas emissions to the environment.

The sintering system according to embodiments of the present disclosure includes: a rotary sintering furnace having an exhaust opening configured to discharge exhaust gas; and an exhaust gas treatment system connected to the exhaust opening and configured to treat the exhaust gas discharged from the rotary sintering furnace. The exhaust gas treatment system includes multi-stage treatment devices connected in series. At least one stage of the multi-stage treatment devices is a dust separation device. The dust separation device is configured to separate dust from the exhaust gas. At least one stage of the multi-stage treatment devices is a spray tower disposed downstream of the dust separation device. The spray tower is configured to wash the exhaust gas that has been treated by the dust separation device.

With the sintering system according to the embodiments of the present disclosure, by performing multi-stage exhaust gas treatments and providing the dust separation device and the spray tower disposed downstream of the dust separation device, dust, coal tar, lower-order alkanes, water vapor, and other impurities in the exhaust gas are removed, improving impurity removal efficiency, removing impurities more thoroughly from the exhaust gas, and reducing the harm of exhaust gas emissions. It is beneficial to protection of the environment and the health of production personnel and surrounding residents.

In addition, the sintering system according to the above embodiments of the present disclosure may also have the following additional technical features.

According to some embodiments of the present disclosure, the dust separation device includes a settling tank. The settling tank includes a tank body and a plurality of baffles disposed in the tank body, and the tank body has a first inlet and a first outlet. The plurality of baffles extend in a vertical direction or in an obliquely downward direction. In a horizontal direction, the plurality of baffles are arranged in a staggered manner at intervals and divide a space in the tank body into a plurality of sub-spaces arranged in the horizontal direction. Two sub-spaces of the plurality of sub-spaces located at two ends of the plurality of sub-spaces in the horizontal direction are connected to the first inlet and the first outlet, respectively. Each of the plurality of baffles has a communication opening, and two sub-spaces of the plurality of sub-spaces adjacent to the baffle are connected to each other through the communication opening. Projections of communication openings of any two adjacent baffles of the plurality of baffles in an arrangement direction of the plurality of baffles are non-overlapping.

According to some embodiments of the present disclosure, the settling tank further has a dust exhaust opening located at a bottom of the settling tank. Each of the plurality of sub-spaces is connected to the dust exhaust opening.

According to some embodiments of the present disclosure, the tank body has a flow guide cavity and a dust collection cavity connected to the flow guide cavity. The flow guide cavity is located above the dust collection cavity. Cross-sectional areas of the dust collection cavity on a horizontal plane gradually decrease away from the flow guide cavity, and the dust exhaust opening is connected to the dust collection cavity.

According to some embodiments of the present disclosure, the dust separation device includes a three-way pipe, a buffer tank, and a cyclone separator. The three-way pipe includes a first pipe body, a second pipe body, and a third pipe body. The first pipe body has an air inlet end connected to the exhaust opening; the first pipe body has an air outlet end connected to an air inlet end of the second pipe body and an air inlet end of the third pipe body; the second pipe body has an air outlet end connected to the cyclone separator; the third pipe body has an air outlet end connected to the buffer tank; the air inlet end of the first pipe body is higher than or equal to the air outlet end of the first pipe body in a vertical direction; the air outlet end of the third pipe body is lower than the air inlet end of the third pipe body in the vertical direction; and an angle between the first pipe body and the second pipe body is a, an angle between the second pipe body and a vertically downward direction is b, and an angle between the third pipe body and the vertically downward direction is c, where a≥90°, b>0°, c≤b.

According to some embodiments of the present disclosure, the dust separation device includes a three-way pipe, a buffer tank, and a cyclone separator. The three-way pipe includes a first pipe body, a second pipe body, and a third pipe body. The first pipe body has an air inlet end connected to the exhaust opening; the first pipe body has an air outlet end connected to an air inlet end of the second pipe body and an air inlet end of the third pipe body; the second pipe body has an air outlet end connected to the cyclone separator; the third pipe body has an air outlet end connected to the buffer tank; each of the first pipe body and the third pipe body extends in a vertical direction; and the second pipe body extends in a horizontal direction.

According to some embodiments of the present disclosure, the buffer tank has a first opening formed at a top of the buffer tank and a second opening formed at a bottom of the buffer tank. The first opening is connected to the three-way pipe, and the second opening is configured to discharge sediment. The cyclone separator has a third opening and a fourth opening that are formed at a top of the cyclone separator and a fifth opening formed at a bottom of the cyclone separator. The third opening is connected to the three-way pipe. The fourth opening is connected to a downstream treatment device of the multi-stage treatment devices, and the fifth opening is configured to discharge the sediment. An on-off valve is disposed at each of the second opening and the fifth opening.

According to some embodiments of the present disclosure, the spray tower includes a tower body, a spray assembly, a liquid redistributor, and a demister. The tower body has a second inlet formed at a side of the tower body and a second outlet formed at a top of the tower body; the spray assembly includes a spray head disposed in the tower body and located between the second inlet and the second outlet; the liquid redistributor is located between the spray head and the second inlet; and the demister is located between the spray head and the second outlet.

According to some embodiments of the present disclosure, a plurality of spray heads are provided and arranged in a plurality of layers in a vertical direction. The liquid redistributor is provided for each of the plurality of layers of spray heads and located below the spray head, and the demister is disposed above the plurality of layers of spray heads.

According to some embodiments of the present disclosure, the exhaust gas treatment system is further connected in series with an induced draft fan. The induced draft fan is configured to drive the exhaust gas to flow in the exhaust gas treatment system.

According to some embodiments of the present disclosure, the exhaust gas treatment system is connected to the exhaust opening through a first connection pipe. Heights of the first connection pipe in a vertical direction increase and then decrease from an end of the first connection pipe to another end of the first connection pipe.

According to some embodiments of the present disclosure, the first connection pipe includes a first pipe segment and a second pipe segment. The exhaust opening is connected to the second pipe segment through the first pipe segment; the first pipe segment is connected to the exhaust gas treatment system through the second pipe segment; the first pipe segment and the second pipe segment extend downwards and away from each other from a connection between the first pipe segment and the second pipe segment; and an angle between the first pipe segment and the second pipe segment is greater than or equal to 60°.

According to some embodiments of the present disclosure, at least one of the exhaust opening and the exhaust gas treatment system is connected to the first connection pipe through a flexible pipe.

According to some embodiments of the present disclosure, a polishing degree Ra of the first connection pipe is smaller than or equal to 0.8 μm; and/or a polishing degree Ra of an inner wall surface of each of the multi-stage treatment devices is smaller than or equal to 0.8 μm.

According to some embodiments of the present disclosure, the rotary sintering furnace has a furnace cavity, an air inlet, and the exhaust opening. The air inlet and the exhaust opening are connected to the furnace cavity. The air inlet is configured to introduce a protection gas into the furnace cavity, and the exhaust opening is configured to discharge the exhaust gas in the furnace cavity. The rotary sintering furnace has a feed inlet and a discharge outlet that are respectively formed at two ends of the rotary sintering furnace in an axial direction of the rotary sintering furnace. Each of the feed inlet and the discharge outlet is connected to the furnace cavity. The feed inlet and the exhaust opening are formed at one end of the rotary sintering furnace in the axial direction of the rotary sintering furnace, and the discharge outlet and the air inlet are formed at one end of the rotary sintering furnace in the axial direction of the rotary sintering furnace.

According to some embodiments of the present disclosure, the sintering system further includes a rapping device. The rapping device is configured to rap the multi-stage treatment devices; and/or the rapping device is configured to rap a first connection pipe, the exhaust gas treatment system being connected to the exhaust opening through the first connection pipe; and/or the rapping device is configured to rap a second connection pipe, two adjacent treatment devices of the multi-stage treatment devices being connected through the second connection pipe.

According to some embodiments of the present disclosure, a thermal insulation structure is disposed outside the first connection pipe and/or the dust separation device.

According to some embodiments of the present disclosure, the sintering system is applied in preparation of new energy materials to perform dynamical sintering on raw materials. The new energy materials include a lithium-ion battery cathode material, and the lithium-ion battery cathode material includes one of lithium iron phosphate, lithium cobalt oxide, and lithium nickel cobalt manganese oxide.

Additional aspects and advantages of the present disclosure will be provided in part in the following description, or will become apparent in part from the following description, or can be learned from practicing of the present disclosure.

### BRIEF DESCRIPTION OF THE DRAWINGS

The above and/or additional aspects and advantages of the present disclosure will become apparent and easily understandable from the following description of embodiments taken in conjunction with the accompanying drawings, in which:

FIG. 1 is a schematic structural view of a sintering system according to an embodiment of the present disclosure.

FIG. 2 is a top view at a settling tank according to an embodiment of the present disclosure.

FIG. 3 is a cross-sectional view at a settling tank according to an embodiment of the present disclosure, with a plurality of baffles arranged in a staggered manner at intervals in a horizontal direction.

FIG. 4 is a cross-sectional view at a settling tank of a comparative solution, with a plurality of baffles arranged in a staggered manner at intervals in a vertical direction.

FIG. 5 is a schematic view of a partial structure of a sintering system according to an embodiment of the present disclosure.

### REFERENCE NUMERALS

sintering system 100;
rotary sintering furnace 10; furnace cavity 11; air inlet 12; exhaust opening 13; feed inlet 14; furnace body 15;
exhaust gas treatment system 20;
dust separation device 30; settling tank 31; tank body 32; first inlet 321; first outlet 322; dust exhaust opening 323; flow guide cavity 324; dust collection cavity 325; baffle 33; communication opening 331; sub-space 34;
three-way pipe 35; first pipe body 351; second pipe body 352; third pipe body 353; buffer tank 36; first opening 361; second opening 362; cyclone separator 37; third opening 371; fourth opening 372; fifth opening 373; blocking member 374;
spray tower 40; tower body 41; second inlet 411; second outlet 412; spray assembly 42; liquid redistributor 43; demister 44;
induced draft fan 51; exhaust pump 52; exhaust pipe 53;
first connection pipe 60; first pipe segment 61; second pipe segment 62; second connection pipe 70; flexible pipe 80; on-off valve 90.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

In the description of the embodiments of the present disclosure, it should be understood that terms such as “center”, “longitudinal”, “lateral”, “length”, “width”, “thickness”, “over”, “below”, “front”, “back”, “left”, “right”, “vertical”, “horizontal”, “top”, “bottom”, “in”, “out”, “clockwise”, “anti-clockwise”, “axial”, “radial” and “circumference” are based on the orientation or position relationship illustrated in the drawings. These terms are only for the convenience of describing the present disclosure and simplifying the description, rather than indicating or implying that the described device or element must have a specific orientation or must be constructed and operated in a specific orientation. Therefore, they cannot be understood as limitations of the present disclosure.

In the description of the present disclosure, “the first feature” and “the second feature” may include at least one of the features, and “plurality” means at least two. The first feature being “on” or “under” the second feature may include the scenarios that the first feature is in direct contact with the second feature, or the first and second features, instead of being in direct contact with each other, are in contact with each other through another feature therebetween. The first feature being “above” the second feature may indicate that the first feature is directly above or obliquely above the second feature, or simply indicate that the level of the first feature is higher than that of the second feature.

A sintering system 100 according to the embodiments of the present disclosure is described below with reference to the accompanying drawings.

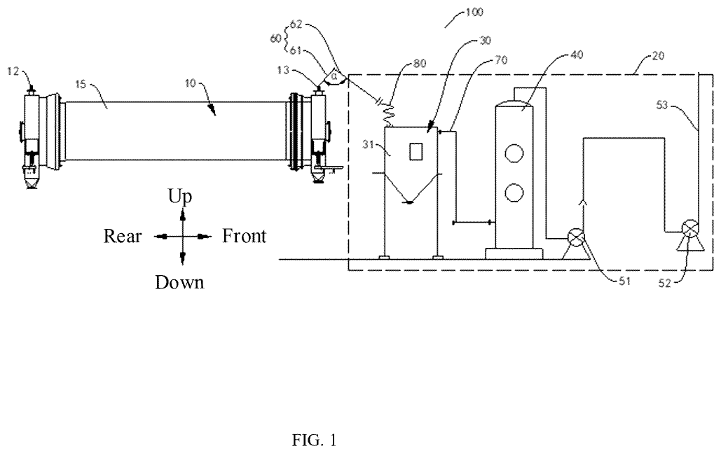

Referring to FIG. 1 to FIG. 5, the sintering system 100 according to the embodiments of the present disclosure may include a rotary sintering furnace 10 and an exhaust gas treatment system 20.

In some embodiments, the rotary sintering furnace 10 has an exhaust opening 13 configured to discharge exhaust gas. The exhaust gas treatment system 20 is connected to the exhaust opening 13 and configured to treat the exhaust gas discharged from the rotary sintering furnace 10. The exhaust gas treatment system 20 includes multi-stage treatment devices connected in series. At least one stage of the multi-stage treatment devices is a dust separation device 30. The dust separation device 30 is configured to separate dust from the exhaust gas. At least one stage of the multi-stage treatment devices is a spray tower 40. The spray tower 40 is located downstream of the dust separation device 30 and configured to wash the exhaust gas that has been treated by the dust separation device 30.

The rotary sintering furnace 10 is used for sintering a material and other operations, and may introduce a protection gas such as an inert gas (like nitrogen) into the rotary sintering furnace 10, which is beneficial to ensuring a protection gas atmosphere inside the rotary sintering furnace 10, to prevent the rotary sintering furnace 10 from having a too high oxygen content and affecting the material sintering, such as lithium iron phosphate. For example, the oxygen content is too high, resulting in oxidation of more lithium iron phosphate into trivalent iron salts and other by-products. By sintering the material under the protection gas atmosphere, it is beneficial to an improvement in a product quality.

Productive dust will be produced during a feeding process of raw materials and a movement sintering process of the material in the rotary sintering furnace 10. Meanwhile, because of moisture and impurities carried by an iron phosphate raw material prepared in the previous processes, water vapor, coal tar, and lower-order alkanes are generated during initial sintering. These productive dust, the water vapor, the coal tar, and the lower-order alkanes are discharged along with the protection gas inside the rotary sintering furnace 10, forming the exhaust gas. The protection gas is introduced into the rotary sintering furnace 10, and the exhaust gas is discharged from the rotary sintering furnace 10 through the exhaust opening 13, to facilitate continuous introduction of the protection gas into the rotary sintering furnace 10, which is beneficial to maintaining a protection gas atmosphere where the material in the rotary sintering furnace 10 is located, and preventing the water vapor, the coal tar, and the lower-order alkanes mixed in the gas from affecting the material sintering and lowering the product quality.

A purification treatment is performed on the exhaust gas discharged from the exhaust opening 13 by the exhaust gas treatment system 20, removing the dust, the coal tar, the water vapor, and other impurities in the exhaust gas, which can prevent the exhaust gas from being directly discharged and causing serious harm to the environment, and is beneficial to protection of the environment and the health of production personnel and surrounding residents. In some embodiments, the dust separation device 30 is capable of separating a large amount of dust contained in the exhaust gas, greatly reducing a dust content in the exhaust gas, and realizing a preliminary impurity removal treatment on the exhaust gas. The exhaust gas that has been treated by the dust separation device 30 may be washed by the spray tower 40 disposed downstream of the dust separation device 30, to separate a small amount of the dust, the coal tar, the lower-order alkanes, the water vapor, and other impurities from the exhaust gas. Further, the impurity removal treatment is performed on the exhaust gas, making exhaust gas purification more thorough, which is more beneficial to emissions and more friendly to the environment.

Multi-stage (that may be two stages, three stages, or more stages of) treatments are performed on the exhaust gas by the dust separation device 30 and the spray tower 40. Moreover, the spray tower 40 is disposed downstream of the dust separation device 30, which is beneficial to performing a staged treatment on the exhaust gas, i.e., a washing treatment is performed on the exhaust gas after a dust removal treatment is performed on the exhaust gas, preventing too much dust from the exhaust gas from causing too low washing efficiency, and preventing the exhaust gas from having too high humidity and causing too low dusting efficiency. In this way, impurity removal efficiency is improved, and the impurities from the exhaust gas are more thoroughly removed.

A plurality of dust separation devices 30 may be provided, which is beneficial to performing dust removal treatments on the exhaust gas many times, and a plurality of spray towers 40 may be provided, which is beneficial to washing the exhaust gas many times, achieving more stages of treatments of the exhaust gas, with higher impurity removal efficiency. Of course, except for the dust separation device 30 and the spray tower 40, the exhaust gas treatment system 20 may also include more other treatment devices to treat the exhaust gas.

With the sintering system 100 according to the embodiments of the present disclosure, by performing multi-stage exhaust gas treatments and providing the dust separation device 30 and the spray tower 40 disposed downstream of the dust separation device 30, the dust, the coal tar, the lower-order alkanes, the water vapor, and other impurities are removed from the exhaust gas, improving the impurity removal efficiency, removing the impurities more thoroughly from the exhaust gas, and reducing the harm of exhaust gas emissions. It is beneficial to the protection of the environment and the health of the production personnel and surrounding residents.

In some embodiments of the present disclosure, the sintering system 100 is applied in preparation of new energy materials to perform dynamical sintering on the raw materials. The new energy materials include a lithium-ion battery cathode material. The lithium-ion battery cathode material includes one of lithium iron phosphate, lithium cobalt oxide, and lithium nickel cobalt manganese oxide. The new energy material, such as the lithium-ion battery cathode material, easily produces the productive dust, the water vapor, the coal tar, the lower-order alkanes, and other impurities during a sintering process. The sintering system 100 of the present disclosure is utilized for sintering the lithium-ion battery cathode material, which can continuously introduce the protection gas into the rotary sintering furnace 10 to take away impurities in the raw materials utilizing the protection gas, reduce an adverse effect of the impurities on the material sintering, and is beneficial to the improvement of the product quality. Moreover, it is possible to perform the impurity removal treatment on the exhaust gas in the rotary sintering furnace 10 and discharge the exhaust gas to an outside world. It is beneficial to the protection of the environment and the health of the production personnel and surrounding residents.

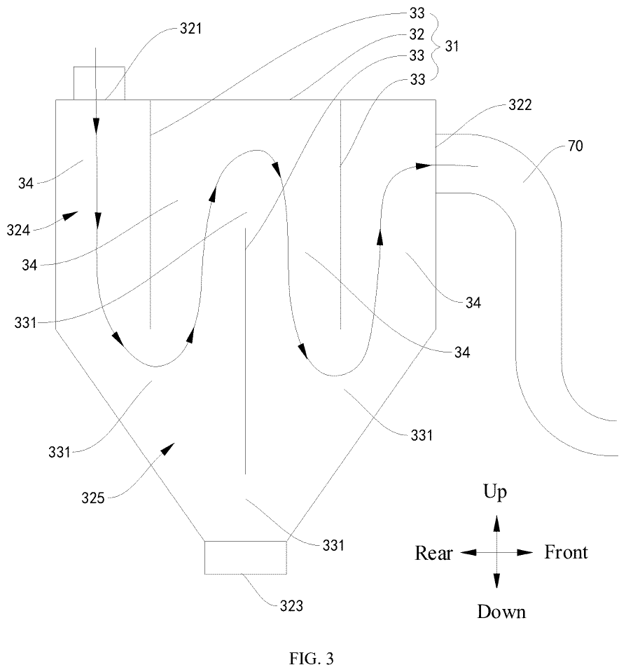

In some embodiments of the present disclosure, as shown in FIG. 1 to FIG. 3, the dust separation device 30 includes a settling tank 31. The settling tank 31 includes a tank body 32 and a plurality of baffles 33 disposed in the tank body 32. The tank body 32 has a first inlet 321 and a first outlet 322. The plurality of baffles 33 extend in a vertical direction (such as an up-down direction shown in FIG. 3) or in an obliquely downward direction (such as forming 5°, 10°, 15°, 20°, 25°, or 30° with a vertically downward direction). In a horizontal direction, the plurality of baffles 33 are arranged in a staggered manner at intervals (such as a front-rear direction shown in FIG. 3) and divide a space in the tank body 32 into a plurality of sub-spaces 34 arranged in the horizontal direction. Two sub-spaces 34 of the plurality of sub-spaces 34 located at two ends of the plurality of sub-spaces 34 in the horizontal direction are connected to the first inlet 321 and the first outlet 322, respectively.

Each of the plurality of baffles 33 has a communication opening 331, two sub-spaces 34 of the plurality of sub-spaces 34 adjacent to the baffle 33 are connected to each other through the communication opening 331. Projections of communication openings 331 formed at any two adjacent baffles 33 of the plurality of baffles 33 in an arrangement direction of the plurality of baffles 33 are non-overlapping. In some embodiments, each of four peripheral edges of the baffle 33 is connected to an inner wall of the tank body 32, and the communication opening 331 is formed through directly trepanning of the baffle 33. Alternatively, the edges of the baffle 33 are at least partially not connected to the inner wall of the tank body 32, and the edges of the baffle 33 and the inner wall of the tank body 32 are enclosed to form the communication opening 331. In the horizontal direction, the plurality of baffles 33 are arranged in a staggered manner at intervals, i.e. projections of the plurality of baffles 33 in the horizontal direction have overlapping portions and non-overlapping portions. The projections of communication openings 331 formed at any two adjacent baffles 33 of the plurality of baffles 33 in the horizontal direction are non-overlapping.

The exhaust gas discharged from the exhaust opening 13 enters the settling tank 31 from the first inlet 321 and is discharged from the settling tank 31 through the first outlet 322. During a process of the exhaust gas in the tank body 32 flowing from the first inlet 321 to the first outlet 322, the dust from the exhaust gas settles under the action of gravity. Moreover, the exhaust gas is blocked by the baffle 33 and is unable to flow directly from the first inlet 321 to the first outlet 322 along a connection line between the first inlet 321 and the first outlet 322. The exhaust gas impacts the baffle 33 during flowing, making the dust easier to settle, which is beneficial to an improvement in dust removal efficiency of the exhaust gas.

Furthermore, the exhaust gas is blocked by the baffle 33 and may only bypass the baffle 33 and enter a sub-space 34 adjacent to the baffle 33 through the communication opening 331, so that the exhaust gas passes through the plurality of sub-spaces 34 sequentially from the first inlet 321 along a curve (such as a curve with arrows as shown in FIG. 3) and flows to the first outlet 322, which prolongs a flow path of the exhaust gas, making more dust settle in an exhaust gas flow process, and improving the dust removal efficiency of the exhaust gas.

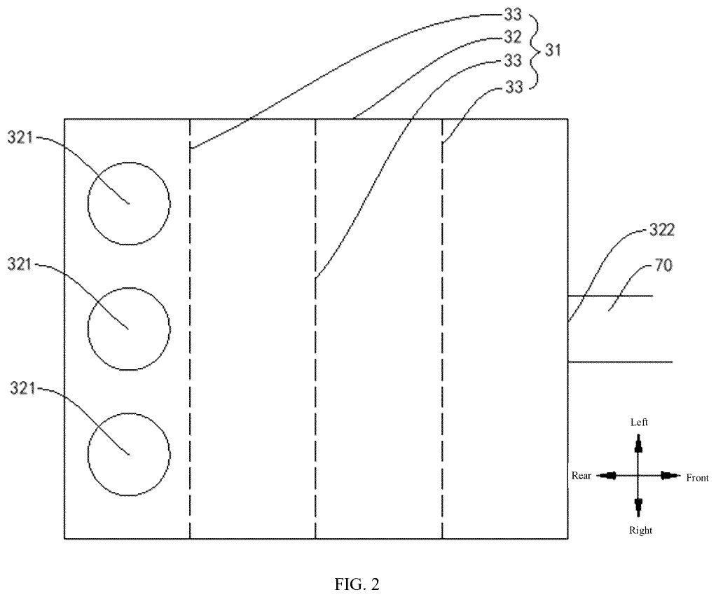

It's worth noting that as shown in FIG. 2, a plurality of first inlets 321 may be formed. When one of the first inlets 321 operates, the rest of first inlets 321 are in a closed state, preventing one of the first inlets 321 from being blocked and causing the exhaust gas discharged from the exhaust opening 13 to be unable to enter the settling tank 31, reducing a probability of the dust separation device 30 being blocked, and improving dust removal reliability. The settling tank 31 may also have an access opening that is configured to perform maintenance and inspection operations such as cleaning a material adhering to the wall and inside the settling tank 31. A plurality of (two, three, or more) access openings may be formed, preferably at a top of the settling tank 31, and are reasonably distributed based on an actual shape and size of the settling tank 31, which is beneficial to an improvement in maintenance and cleaning effects and operation efficiency.

The first inlet 321 and the first outlet 322 are arranged in the horizontal direction. Moreover, the projections of the communication openings 331 formed at any two adjacent baffles 33 do not overlap in the horizontal direction. In this way, it is beneficial to prolonging the flow path of the exhaust gas, to improve blocking effects of the plurality of baffles 33 on the exhaust gas, and to an improvement in a settling rate of the dust from the exhaust gas.

In some embodiments, the settling tank 31 further has a dust exhaust opening 323 located at a bottom of the settling tank 31. Each of the plurality of sub-spaces 34 is connected to the dust exhaust opening 323. It is beneficial to settling of the dust settled in the plurality of sub-spaces 34 to the dust exhaust opening 323 at the bottom of the settling tank 31, to facilitate discharge of the dust, a reduction in a possibility where the settling tank 31 such as the communication opening 331 is blocked, and an improvement in reliability of an exhaust gas treatment at the settling tank 31.

In some embodiments, the tank body 32 has a flow guide cavity 324 and a dust collection cavity 325 connected to the flow guide cavity 324. The flow guide cavity 324 is located above the dust collection cavity 325. Cross-sectional areas of the dust collection cavity 325 on a horizontal plane gradually decrease away from the flow guide cavity 324, and the dust exhaust opening 323 is connected to the dust collection cavity 325. The dust collection cavity 325 is set to taper downwards, i.e., to form a conical structure. An upward flow guide effect may be formed on an airflow by a side wall of the dust collection cavity 32, causing the airflow to tend to flow around the plurality of sub-spaces 34, while facilitating centralized collection of the dust.

A solution where the plurality of sub-spaces 34 are arranged in the horizontal direction is beneficial to making bottoms of the plurality of sub-spaces 34 be in direct communication with the dust exhaust opening 323, respectively. The dust may be directly settled in the dust exhaust opening 323, instead of continuing to move with the airflow in a long flow path or sliding along surfaces of the baffles 33 to be alternated and transferred between the plurality of baffles 33, and thus keep mixing with and separating from the airflow repeatedly, improving the dust removal efficiency of the exhaust gas, and facilitating rapid settlement and removal of the dust. Meanwhile, a problem where accumulated dust increases with an increase in an operation time and affects a rate and effect of performing dust settlement and separation on subsequently introduced exhaust gas, and a problem where the dust accumulation in the baffle 33 causes cleaning difficulties are avoided.

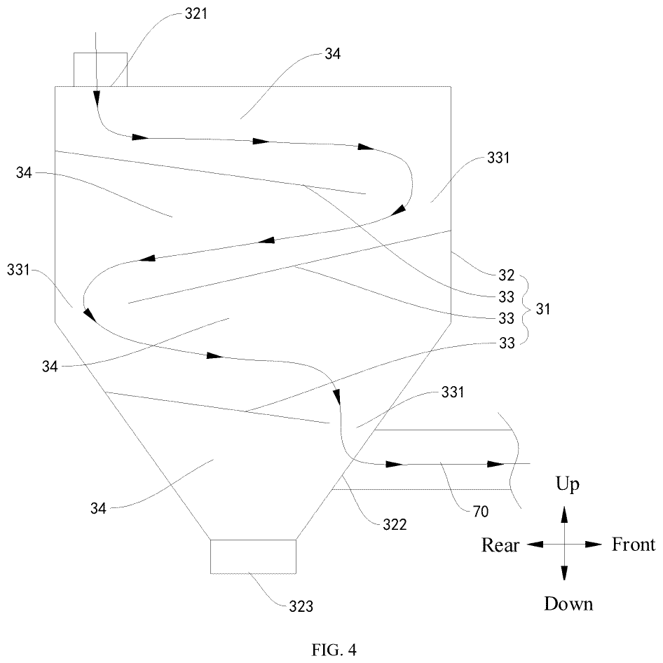

For example, a solution shown in FIG. 4 is taken as a comparative example. In this comparative example, the baffle 33 obliquely extends downwards in the horizontal direction. In the vertical direction, the plurality of baffles 33 are arranged in a staggered manner at intervals and divide the space in the tank body 32 into a plurality of sub-spaces 34 arranged in the vertical direction. Two sub-spaces 34 located at two ends in the vertical direction are connected to the first inlet 321 and the first outlet 322, respectively. The first inlet 321 may be formed at an upper or lower side of the first outlet 322. In the vertical direction, the plurality of baffles 33 are arranged in a staggered manner at intervals, i.e., projections of the plurality of baffles 33 in the vertical direction has overlapping portions and non-overlapping portions. Projections of communication openings 331 formed at any two adjacent baffles 33 do not overlap in the vertical direction.

In this comparative solution, although the arrangement of the plurality of baffles 33 may also extend the flow path of the exhaust gas to improve a blocking effect on the exhaust gas, the dust that has settled due to gravity needs to continue to move along a winding airflow flow path before it can reach and be collected at a bottom of the tank body 32, greatly affecting dust separation and collection efficiency. Moreover, the dust will deposit on a baffle 33 obliquely arranged, resulting in difficult cleaning after long-term accumulation of the dust. Meanwhile, the accumulated dust slides downwards along the surface of the baffle 33, and thus is separated from the baffle 33 to re-mix with the airflow, leading to the need for repeated settling. Alternatively, the accumulated dust falls onto the lower baffle 33 and causes dust to raise due to its impact force, deteriorating a dust separation effect.

One, two, or more settling tanks 31 may be provided, which is beneficial to realization of multi-stage treatments on the exhaust gas. For example, in some embodiments, there are two settling tanks 31. In one of the two settling tanks 31, the baffle 33 obliquely extends downwards in the horizontal direction. In the other one of the two settling tanks 31, the baffle 33 extends in the vertical direction.

In some embodiments, an on-off valve 90 is provided at the dust exhaust opening 323 at the bottom of the settling tank 31. An opening degree of the dust exhaust opening 323 may be controlled by the on-off valve 90, making it convenient to open the dust exhaust opening 323 to discharge the accumulated dust in the settling tank 31. Alternatively, the on-off valve 90 controls the dust exhaust opening 323 not to be fully opened to perform dust settling and discharging functions simultaneously or closes the dust exhaust opening 323 to prevent an external gas from being introduced into the settling tank 31 and thus into the exhaust opening 13, which is beneficial to ensuring the protection gas atmosphere in the rotary sintering furnace 10. In the present disclosure, one or more on-off valves 90 may be provided. Each on-off valve 90 may be a butterfly valve, a ball valve, or the like.

The settling tank 31 is uneasily blocked. Moreover, only one outlet is needed for the settling tank 31 to discharge sediment. Since a sediment discharge opening of the settling tank 31 is also an exposed opening where the exhaust gas treatment system 20 is in contact with the outside world, i.e., while achieving a high-efficiency dust separation effect, it is beneficial to a reduction in the exposed opening where the exhaust gas is in contact with outside air, reducing air entering the settling tank 31 from an air-break opening and thus entering the rotary sintering furnace 10 from the exhaust opening 13, reducing oxygen contents in the exhaust gas treatment system 20 and the rotary sintering furnace 10, and preventing the oxygen contents of the exhaust gas treatment system 20 and the rotary sintering furnace 10 from exceeding the standard. It is beneficial to control of an oxygen content of the sintered product and the improvement of the product quality.

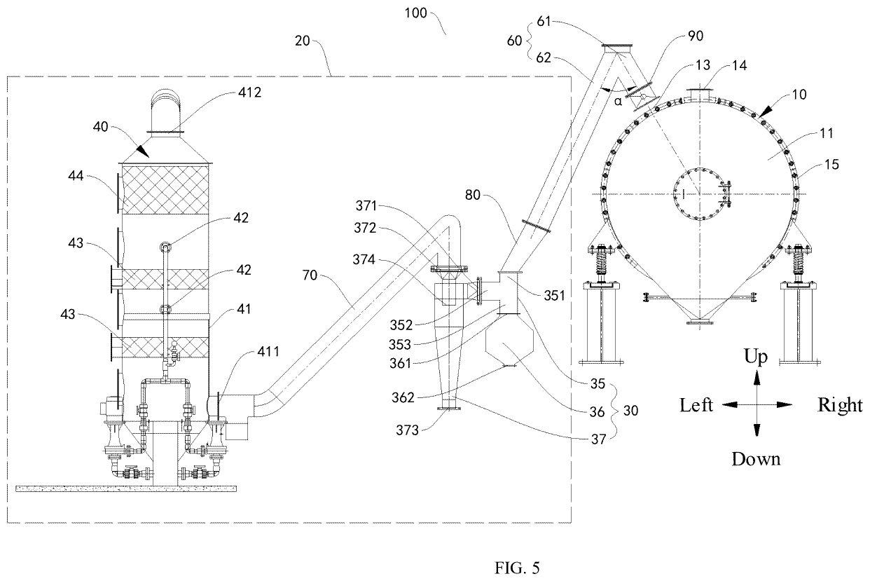

In some embodiments of the present disclosure, as shown in FIG. 5, the dust separation device 30 includes a three-way pipe 35, a buffer tank 36, and a cyclone separator 37. The three-way pipe 35 includes a first pipe body 351, a second pipe body 352, and a third pipe body 353. The first pipe body 351 has an air inlet end connected to the exhaust opening 13. The first pipe body 351 has an air outlet end connected to an air inlet end of the second pipe body 352 and an air inlet end of the third pipe body 353. The second pipe body 352 has an air outlet end connected to the cyclone separator 37. The third pipe body 353 has an air outlet end connected to the buffer tank 36. The air inlet end of the first pipe body 351 is higher than or equal to the air outlet end of the first pipe body 351 in a vertical direction. The air outlet end of the third pipe body 353 is lower than the air inlet end of the third pipe body 353 in the vertical direction. An angle between the first pipe body 351 and the second pipe body 352 is a, an angle between the second pipe body 352 and a vertically downward direction is b, and an angle between the third pipe body 353 and the vertically downward direction is c, where a≥90°, b>0°, c≤b.

The exhaust gas discharged from the exhaust opening 13 enters the first pipe body 351, so that the exhaust gas discharged into the first pipe body 351 may at least be discharged towards the air outlet end of the first pipe body 351 under the action of gravity, to be discharged towards the air inlet end of the second pipe body 352 and the air inlet end of the third pipe body 353, reducing a possibility where the exhaust gas in the first pipe body 351 occurs backflow, and making the exhaust gas emissions more reliable.

The exhaust gas discharged from the exhaust opening 13 enters the three-way pipe and then is discharged towards the buffer tank 36 and the cyclone separator 37. In this way, when the exhaust gas passes through the buffer tank 36, the dust with large particles in the exhaust gas moves downwards due to its own gravity and settles in the buffer tank 36, which is beneficial to making more dust with large particles in the exhaust gas enter the buffer tank 36 through the third pipe body 353, realizing the dust removal treatment on the exhaust gas.

Furthermore, it is beneficial to a reduction in wind resistance by discharging the exhaust gas from the first pipe body 351 to the second pipe body 352, making the exhaust gas be discharged into the cyclone separator 37 more quickly, and the improvement of the exhaust gas treatment efficiency. After the exhaust gas is discharged into the cyclone separator 37, dust with small particles in the exhaust gas undergoes a centrifugal movement in the cyclone separator 37 and is thrown towards a peripheral wall of the cyclone separator 37, and thus settles to a bottom of the cyclone separator 37, realizing the dust removal treatment on the exhaust gas. That is, the multi-stage treatments are performed on the exhaust gas in the dust separation device 30. In particular, it is beneficial to removal of the dust with large particles and dust with small particles in the exhaust gas, with higher dust removal efficiency.

It is worth noting that the dust removal treatment may be performed by the buffer tank 36 on the exhaust gas passing through the third pipe body 353 without the need for the exhaust gas entering the buffer tank 36, i.e., when the exhaust gas passes through the third pipe body 353, the dust with large particles mixed in the exhaust gas moves downwards due to its own gravity, enters and is collected in the buffer tank 36, while the gas may directly enter the cyclone separator 37 through the second pipe body 352, shortening a dust removal time of the exhaust gas at the buffer tank 36, with the higher dust removal efficiency.

A connection between the exhaust opening 13, the buffer tank 36, and the cyclone separator 37 is realized through the three-way pipe 35. Only one opening needs to be formed at the buffer tank 36, and the exhaust opening 13 may be connected to the cyclone separator 37 through the opening. It is unnecessary to form a plurality of openings at the buffer tank 36 to be connected to the exhaust opening 13 and the cyclone separator 37, respectively. The number of openings of the buffer tank 36 is reduced, and a region where the buffer tank 36 is connected to the outside world is thus reduced. It is beneficial to ensuring a protection gas atmosphere in the buffer tank 36, and thus ensuring the protection gas atmosphere in the rotary sintering furnace 10.

It should be noted that only when the air inlet end of the second pipe body 352 is located directly below the air outlet end in the vertical direction, the angle b between the second pipe body 352 and the vertical direction may be equal to 0°, i.e., the exhaust gas at the second pipe body 352 may flow vertically upwards from the air inlet end to the air outlet end to enter the cyclone separator 37 instead of flowing vertically downwards from the air inlet end to the air outlet end, making more dust from the exhaust gas enter the buffer tank 36 instead of the cyclone separator 37, which is beneficial to an improvement in treatment efficiency of the buffer tank 36 and the cyclone separator 37 for the exhaust gas.

It can be understood that b is unequal to 0°, i.e., the second pipe body 352 does not extend downwards in the vertical direction, and c≤b, i.e., the third pipe body 353 may be closer to the vertically downward direction than the second pipe body 352, making more exhaust gas discharged from the first pipe body 351 be discharged towards the third pipe body 353. It is beneficial to realization of the settlement of the dust with large particles of the exhaust gas in the buffer tank and the improvement of the exhaust gas treatment efficiency. For example, in some embodiments, a is 180°, b is 90°, and c is 0°, i.e., the air inlet end of the first pipe body 351 extends in the horizontal direction towards the air outlet end, the air inlet end of the second pipe body 352 extends in the horizontal direction towards the air outlet end, and the air inlet end of the third pipe body 353 extends in the vertically downward direction towards the air outlet end. In some embodiments, a is 90°, b is 45°, and c is 30°, i.e., the air inlet end of the first pipe body 351 extends obliquely downwards towards the air outlet end, the air inlet end of the second pipe body 352 extends obliquely downwards towards the air outlet end, and the air inlet end of the third pipe body 353 extends obliquely downwards towards the air outlet end. Moreover, the third pipe body 353 is closer to the vertically downward direction than the second pipe body 352. It is beneficial to a reduction in wind resistance of exhaust gas emissions and making more dust with large particles in the exhaust gas be discharged towards the settling tank 36.

In some embodiments, as shown in FIG. 5, the dust separation device 30 includes the three-way pipe 35, the buffer tank 36, and the cyclone separator 37. The three-way pipe 35 includes the first pipe body 351, the second pipe body 352, and the third pipe body 353. The air inlet end of the first pipe body 351 is connected to the exhaust opening 13. The first pipe body 351 has an air outlet end connected to the air inlet end of the second pipe body 352 and the air inlet end of the third pipe body 353. The second pipe body 352 has an air outlet end connected to the cyclone separator 37. The third pipe body 353 has an air outlet end connected to the buffer tank 36. Each of the first pipe body 351 and the third pipe body 353 extends in the vertical direction. The second pipe body 352 extends in the horizontal direction.

The exhaust gas discharged from the exhaust opening 13 enters the first pipe body 351, so that more exhaust gas in the first pipe body 351 is discharged in the vertical direction towards the second pipe body 352 and discharged from the second pipe body 352 in the vertical direction towards the buffer tank 36. Moreover, the dust with large particles in the exhaust gas is more easily discharged in the vertical direction into the buffer tank 36 under the action of its own gravity, which is beneficial to the removal of more dust such as the dust with large particles in the exhaust gas. The exhaust gas after being subject to dust removal by the buffer tank 36 and exhaust gas that carries the dust with small particles and is discharged from the first pipe body 351 may be discharged towards the second pipe body 352, and discharged in the second pipe body 352 towards the cyclone separator 37 in the horizontal direction, to perform a further dust removal treatment on the exhaust gas through the cyclone separator 37, which is beneficial to realization of the staged treatment on the exhaust gas in the dust separation device 30 and the improvement of the dust removal efficiency.

In some embodiments, as shown in FIG. 5, the buffer tank 36 has a first opening 361 formed at a top of the buffer tank 36 and a second opening 362 formed at a bottom of the buffer tank 36. The first opening 361 is connected to the three-way pipe 35, and the second opening 362 is configured to discharge sediment. The cyclone separator 37 has a third opening 371 and a fourth opening 372 that are formed at a top of the cyclone separator 37 and a fifth opening 373 formed at a bottom of the cyclone separator 37. The third opening 371 is connected to the three-way pipe 35. The fourth opening 372 is connected to a downstream treatment device of the multi-stage treatment devices. The fifth opening 373 is configured to discharge the sediment. Each of the second opening 362 and the fifth opening 373 is provided with the on-off valve 90.

By forming the first opening 361 at the top of the buffer tank 36, the exhaust gas discharged from the exhaust opening 13 may be discharged from the top of the buffer tank 36 towards the buffer tank 36, so that the dust with large particles in the exhaust gas settles from the top of the buffer tank 36 to the bottom of the buffer tank 36 under the action of its own gravity, prolonging a settling path of the dust with large particles to improve the dust removal efficiency of the exhaust gas. The dust with large particles that settles to the bottom of the buffer tank 36 accumulates together to form the sediment. The sediment may be discharged through the second opening 362 at the bottom of the buffer tank 36 and the on-off valve 90 at the second opening 362. In some embodiments, an opening degree of the second opening 362 may be controlled by the on-off valve 90, making it convenient to open the second opening 362 to discharge the sediment in the buffer tank 36, or to control the second opening 362 to be opened partially to perform the dust settling and discharging functions simultaneously, or to close the second opening 362 to prevent the external gas from entering the buffer tank 36 through the second opening 362, thus ensuring the protection gas atmosphere in the rotary sintering furnace 10.

By forming the third opening 371 at the top of the cyclone separator 37, the exhaust gas in the three-way pipe 35 may be discharged into the cyclone separator 37 from the top of the cyclone separator 37, so that the dust from the exhaust gas settles to the bottom of the cyclone separator 37 under the action of its own gravity and a centrifugal effect of the cyclone separator 37, prolonging the settling path of the dust to improve the dust removal efficiency of the exhaust gas. The dust that settles to the bottom of the cyclone separator 37 accumulates together to form the sediment. The sediment may be discharged through the fifth opening 373 at the bottom of the cyclone separator 37 and the on-off valve 90 at the fifth opening 373. In some embodiments, the opening degree of the fifth opening 373 may be controlled by the on-off valve 90, making it convenient to open the fifth opening 373 to discharge the sediment in the cyclone separator 37, or to control the fifth opening 373 to be opened partially to perform centrifugal settling and discharging functions of the dust simultaneously, or to close the fifth opening 373 to prevent the external gas from entering the cyclone separator 37 through the fifth opening 373, thus ensuring the protection gas atmosphere in the rotary sintering furnace 10.

After the exhaust gas undergoes centrifugal settling in the cyclone separator 37, more dust is removed, making the exhaust gas lighter and easier to rise to the top of the cyclone separator 37, and be discharged through the fourth opening 372 at the top of the cyclone separator 37 to the downstream treatment device such as the spray tower 40, to perform the next stage of impurity removal operations, realizing purification treatments on the exhaust gas by the multi-stage treatment devices sequentially.

The exhaust gas may enter along the third opening 371 in a tangential direction of the cyclone separator 37, to improve tangential acceleration of the exhaust gas, making the exhaust gas accelerate to perform the centrifugal movement in the cyclone separator 37 and thus improving a centrifugal dust removal effect on the exhaust gas. It is worth noting that as shown in FIG. 5, the fourth opening 372 is formed at an upper side of the third opening 371. Moreover, a blocking member 374 is provided between the third opening 371 and the fourth opening 372. In this way, the exhaust gas discharged into the cyclone separator 37 through the third opening 371 is not easy to be directly discharged from the fourth opening 372, improving the dust removal reliability of the exhaust gas.

The buffer tank 36 may be a hollow tank body, i.e., there is no structure inside the buffer tank 36, which is beneficial to making the dust from the exhaust gas settle to the bottom of the buffer tank 36. The bottom of the buffer tank 36 may be designed to be in an inverted cone shape, facilitating discharge of the sediment from a conical opening at the bottom of the buffer tank 36. Specific sizes of the buffer tank 36 and the cyclone separator 37 may be determined as data such as a flow speed of the exhaust gas, the dust content in the exhaust gas, and a particle size of the dust. For example, in some specific embodiments, the dust content in the exhaust gas is 30 kg per day, the flow speed of the exhaust gas ranges from 0.2 m/s to 0.8 m/s, and a volume of the buffer tank 36 is 1 m³.

In some embodiments, there are a plurality of dust separation devices 30. At least one of the dust separation devices 30 includes the settling tank 31. At least one of the dust separation devices 30 includes the three-way pipe 35, the buffer tank 36, and the cyclone separator 37, realizing multi-stage dust removal of the exhaust gas.

Since an interior of the rotary sintering furnace 10 has a high-temperature sintering environment, the dust separation device 30 is connected to the exhaust opening 13 formed in the rotary sintering furnace 10. In some embodiments of the present disclosure, a thermal insulation structure is disposed outside the dust separation device 30. For example, thermal insulation cotton, a thermal insulation housing, or the like may be provided. It is beneficial to preventing moisture in the exhaust gas at the dust separation device 30 from condensing and causing blocking, making the exhaust gas flow more smoothly, and improving the exhaust gas treatment efficiency. A thickness of the thermal insulation cotton may be greater than or equal to 10 mm. For example, the thickness of the thermal insulation cotton may be set to 10 mm, 20 mm, 30 mm, 40 mm, or 50 mm. The thermal insulation housing may be a thermal-insulation metal housing or a thermal-insulation plastic housing. For example, the thermal insulation housing may be a thermal-insulation aluminum shell, a polyvinyl chloride (PVC) thermal-insulation shell, or a polyvinylidene fluoride (PVDF) thermal-insulation shell.

In some embodiments of the present disclosure, as shown in FIG. 1 and FIG. 5, the spray tower 40 includes a tower body 41, a spray assembly 42, a liquid redistributor 43, and a demister 44. The tower body 41 has a second inlet 441 formed at a side of the tower body 41 and a second outlet 412 formed at a top of the tower body 41. The spray assembly 42 includes a spray head disposed in the tower body 41 and located between the second inlet 411 and the second outlet 412. The liquid redistributor 43 is located between the spray head and the second inlet 411. The demister 44 is located between the spray head and the second outlet 412.

After the exhaust gas enters the spray tower 40 from the dust separation device 30 through the second inlet 411, liquid may be sprayed onto the exhaust gas through the spray head at an upper side of the second inlet 411, so that a small amount of the dust, the coal tar, the lower-order alkanes, and other impurities in the exhaust gas adhere to the liquid and fall to the bottom of the tower body 41, realizing the impurity removal of the exhaust gas. Moreover, the liquid sprayed by the spray head passes through the liquid redistributor 43 before being sprayed to the second inlet 411. The liquid may be dispersed by the liquid redistributor 43, making the sprayed liquid more evenly distributed inside the tower body 41 to be in contact with more exhaust gas, and having a better impurity removal effect on the exhaust gas.

After a small amount of the dust, the coal tar, the lower-order alkanes, and other impurities are removed from the exhaust gas through the spray assembly 42, the exhaust gas becomes lighter and easily rises to the second outlet 412 above the second inlet 411. Moreover, during a process of the exhaust gas rising to the second outlet 412, the exhaust gas passes through the demister 44, which is beneficial to removing the water vapor mixed in the exhaust gas by the demister 44, performing further impurity removal on the exhaust gas, reducing a possibility of the second outlet 412 being blocked due to the condensation of the moisture in the exhaust gas, and making the exhaust gas easier to be discharged.

The spray assembly 42 may include a pipeline. The liquid redistributor 43 may be a mesh. The demister 44 may be a grid demister. Each of the spray assembly 42, the liquid redistributor 43, and the demister 44 may be made of stainless steel.

In some embodiments, a sewage discharge opening is formed at the bottom of the tower body 41, and a sewage pump is provided at the sewage discharge opening. The sewage pump may drive sewage to flow to be discharged from the sewage discharge opening.

In some embodiments, the spray tower 40 is provided with a water suction pump connected to the bottom of the tower body 41. The water suction pump may pump the liquid stratified from the sewage at the bottom of the tower body 41 and transport the liquid to the spray assembly 42 to recycle the spraying liquid. Moreover, the sewage is uneasily extracted, which is beneficial to saving water.

In some embodiments, as shown in FIG. 5, a plurality of spray heads are provided and arranged in a plurality of layers in a vertical direction. The liquid redistributor 43 is provided for each of the plurality of layers of spray heads and located below the spray head. The demister 44 is disposed above the plurality of layers of spray heads. Through cooperation of the plurality of layers of spray heads and the liquid redistributor 43, it is possible to perform spraying treatments on the exhaust gas at various places inside the tower body 41 in the vertical direction many times, which has a more thorough impurity removal treatment on a small amount of the dust, the coal tar, and other impurities in the exhaust gas. Then, the water vapor in the exhaust gas after being subject to spraying and impurity removal many times is removed by the demister 44, improving the impurity removal efficiency of the exhaust gas.

In some embodiments of the present disclosure, a polishing degree Ra of an inner wall of the treatment device is smaller than or equal to 0.8 μm. In this way, the inner wall of the treatment device is made relatively smooth, which is beneficial to a reduction in an adhesion rate of the impurities of the exhaust gas in the treatment device and acceleration of the flow speed of the exhaust gas. For example, the polishing degree Ra is 0.4 μm, 0.6 μm, or 0.8 μm. Especially for the lithium-ion battery cathode material, impurities are easily generated during the sintering of the lithium-ion battery cathode material. In this way, the polishing degree Ra of the inner wall of the treatment device is smaller than or equal to 0.8 μm, with the better impurity removal effect on the exhaust gas during the exhaust gas treatment.

In some embodiments, the sintering system 100 further includes a rapping device. The rapping device is configured to rap the treatment device, reducing adhesion and accumulation problems of the dust, the coal tar, and other impurities in the treatment device, and improving the impurity removal efficiency.

In some embodiments of the present disclosure, as shown in FIG. 1, the exhaust gas treatment system 20 is further connected in series with an induced draft fan 51. The induced draft fan 51 is configured to drive the exhaust gas to flow in the exhaust gas treatment system 20, enabling the exhaust gas discharged from the exhaust opening 13 to flow through the multi-stage treatment devices without being easily blocked. A wind resistance impact on the exhaust gas during its flow in the exhaust gas treatment system 20 is reduced, and the reliability of the exhaust gas treatment is improved. Moreover, under the action of the induced draft fan 51, the outside air is prevented from easily entering the exhaust gas treatment system 20, which is beneficial to ensuring the protection gas atmosphere in the rotary sintering furnace 10.

For example, in some embodiments, the induced draft fan 51 may provide an extraction force to the exhaust gas discharged from the exhaust opening 13, so that the exhaust gas is extracted from the spray tower 40 after passing through the dust separation device 30 and the spray tower 40. Alternatively, the induced draft fan 51 may provide a blowing force to the exhaust gas discharged from the spray tower 40, to blow the exhaust gas out of the spray tower 40.

In some embodiments, the exhaust gas treatment system 20 also provided with an exhaust pump 52 and an exhaust pipe 53 that are connected in series at a tail portion of the exhaust gas treatment system 20. The exhaust pipe 53 extends upwards in the vertical direction. The exhaust pump 52 is configured to discharge the exhaust gas discharged from the multi-stage treatment devices to the exhaust pipe 53, to realize emissions of the treated exhaust gas at high altitude, which is beneficial to the protection of the environment and the health of the production personnel and surrounding residents.

In some embodiments of the present disclosure, as shown in FIG. 1 and FIG. 5, the exhaust gas treatment system 20 is connected to the exhaust opening 13 through a first connection pipe 60. Heights of the first connection pipe 60 in a vertical direction increase and then decrease from an end of the first connection pipe 60 to another end of the first connection pipe 60. The heights refer to height positions in the vertical direction, i.e., height positions of various parts of the first connection pipe 60 in the vertical direction increase and then decrease from the one end of the first connection pipe 60 to the other end of the first connection pipe 60, or distances between points on a center line of the first connection pipe 60 and the horizontal reference plane increase and then decrease from the one end of the first connection pipe 60 to the other end of the first connection pipe 60. In this way, the first connection pipe 60 is constructed into an inverted V-shape or an inverted U-shape, without a nearly horizontal pipe segment where the dust easily accumulates, reducing dust accumulation in the first connection pipe 60 to make the first connection pipe 60 uneasily blocked, improving the exhaust gas treatment efficiency.

The first connection pipe 60 may be made of materials such as metal or alloy. A length of the first connection pipe 60 may be determined based on relative positions of the rotary sintering furnace 10 and the exhaust gas treatment system 20 that are placed during actual use.

In some embodiments, as shown in FIG. 1 and FIG. 5, the first connection pipe 60 includes a first pipe segment 61 and a second pipe segment 62. The exhaust opening 13 is connected to the second pipe segment 62 through the first pipe segment 61. The first pipe segment 61 is connected to the exhaust gas treatment system 20 through the second pipe segment 62. The first pipe segment 61 and the second pipe segment 62 extend downwards and away from each other from a connection between the first pipe segment 61 and the second pipe segment 62. An angle α between the first pipe segment 61 and the second pipe segment 62 is greater than or equal to 60°.

The exhaust gas discharged from the exhaust opening 13 passes through the first pipe segment 61 and the second pipe segment 62 sequentially and then flows towards the treatment device, causing the exhaust gas in the first connection pipe 60 to flow obliquely upwards and then flow obliquely downwards. Moreover, the angle α between the first pipe segment 61 and the second pipe segment 62 is greater than or equal to 60°, which is beneficial to a reduction in wind resistance of the exhaust gas in the first connection pipe 60, and an increase in a flow speed of the exhaust gas in the first connection pipe 60, enabling the exhaust gas to quickly enter the second pipe segment 62 from the first pipe segment 61. Moreover, in the second pipe segment 62, the exhaust gas flows downwards towards the treatment device under its own gravity, reducing a residence time of the exhaust gas in the first connection pipe 60 to reduce a possibility where the dust accumulation occurs in the first connection pipe 60, making the first connection pipe 60 uneasily blocked due to the impurity deposition, and improving the exhaust gas treatment efficiency. The angle α between the first pipe segment 61 and the second pipe segment 62 may be 60°, 70°, or 80°.

In some embodiments, the exhaust gas treatment system 20 is also connected in series with the induced draft fan 51. By using the induced draft fan 51, a negative pressure may be created in the first connection pipe 60 through pumping to reduce pipeline resistance of the first connection pipe 60 to the exhaust gas, increasing the flow speed of the exhaust gas, and reducing the dust accumulation in the first connection pipe 60.

In some embodiments, as shown in FIG. 1 and FIG. 5, at least one of the exhaust opening 13 and the exhaust gas treatment system 20 is connected to the first connection pipe 60 through a flexible pipe 80. The flexible pipe 80 may occur deformation (such as extendable deformation or bending deformation) to adapt to a movement of the at least one of the exhaust opening 13 and the exhaust gas treatment system 20 relative to the first connection pipe 60 (such as expansion and extendable deformation of the furnace body 15 of the rotary sintering furnace 10 when switching between a cold state and a high-temperature state). In this way, the at least one of the exhaust opening 13 and the exhaust gas treatment system 20 is uneasily separated from the first connection pipe 60, and a connection between the at least one of the exhaust opening 13 and the exhaust gas treatment system 20 and the first connection pipe 60 is relatively reliable. Moreover, a possibility of the outside air entering the rotary sintering furnace 10 through a position where the at least one of the exhaust opening 13 and the exhaust gas treatment system 20 is connected to the first connection pipe 60 is reduced, which is beneficial to ensuring the protection gas atmosphere in the rotary sintering furnace 10. Moreover, it is possible to reduce exhaust gas leakage and improve the reliability of the exhaust gas flowing from the rotary sintering furnace 10 to the exhaust gas treatment system 20.

For example, the exhaust opening 13 and the first connection pipe 60 are rigidly connected, such as by welding, riveting, or through flanges and bolts. Moreover, the exhaust gas treatment system 20 is connected to the first connection pipe 60 through the flexible pipe 80. Alternatively, both the exhaust opening 13 and the exhaust gas treatment system 20 are connected to the first connection pipe 60 through the flexible pipe 80.

The impurities accumulated in the flexible pipe 80 may be poured into the downstream, such as the first connection pipe 60 or the exhaust gas treatment system 20, by shaking the flexible pipe 80 manually or with a machine, reducing impurity accumulation and even blockage in the flexible pipe 80, increasing the flow speed of the exhaust gas. Moreover, the flexible pipe 80 is easy to replace. The flexible pipe 80 may be made of materials such as metal or alloy.

In some embodiments of the present disclosure, a polishing degree Ra of the first connection pipe 60 is smaller than or equal to 0.8 μm, making an inner wall surface of the first connection pipe 60 relatively smooth. It is beneficial to a reduction in an adhesion rate of the impurities of the exhaust gas in the first connection pipe 60 and a reduction in a possibility where the first connection pipe 60 is blocked since the impurities adhere to the wall. For example, the polishing degree Ra may be 0.4 μm, 0.6 μm, or 0.8 μm. Especially for the lithium-ion battery cathode material, the impurities are easily generated during the sintering of the lithium-ion battery cathode material, making the polishing degree Ra of the first connection pipe 60 smaller than or equal to 0.8 μm, and having a better impurity removal effect on the exhaust gas during the exhaust gas treatment process.

Since the interior of the rotary sintering furnace 10 has the high-temperature sintering environment, and the first connection pipe 60 is connected to the exhaust opening 13 formed in the rotary sintering furnace 10, in some embodiments, the thermal insulation structure is disposed outside the first connection pipe 60. For example, the thermal insulation cotton, thermal insulation housing, or the like may be provided. It is beneficial to preventing the moisture in the exhaust gas at the first connection pipe 60 from condensing and causing blocking, making the exhaust gas flow more smoothly and improving the exhaust gas treatment efficiency. The thickness of the thermal insulation cotton may be greater than or equal to 10 mm. For example, the thickness of the thermal insulation cotton may be set to 10 mm, 20 mm, 30 mm, 40 mm, or 50 mm. The thermal insulation housing may be the thermal-insulation metal housing or thermal-insulation plastic housing. For example, the thermal insulation housing may be the thermal-insulation aluminum shell, polyvinyl chloride (PVC) thermal-insulation shell, or polyvinylidene fluoride (PVDF) thermal-insulation shell.

In some embodiments, the sintering system 100 further includes the rapping device. The rapping device is configured to rap the first connection pipe 60, and the exhaust gas treatment system 20 is connected to the exhaust opening 13 through the first connection pipe 60, reducing the adhesion and accumulation problems of the dust, the coal tar, and other impurities in the first connection pipe 60, increasing the flow speed of the exhaust gas in the first connection pipe 60, and improving the impurity removal efficiency.

In some embodiments of the present disclosure, as shown in FIG. 1, the rotary sintering furnace 10 has a furnace cavity 11, an air inlet 12 and the exhaust opening 13. The air inlet 12 and the exhaust opening 13 are connected to the furnace cavity 11. The air inlet 12 is configured to introduce a protection gas into the furnace cavity 11, and the exhaust opening 13 is configured to discharge the exhaust gas in the furnace cavity 11. The rotary sintering furnace 10 has a feed inlet 14 and a discharge outlet that are respectively formed at two ends of the rotary sintering furnace 10 in an axial direction of the rotary sintering furnace 10. Each of the feed inlet 14 and the discharge outlet is connected to the furnace cavity 11. The feed inlet 14 and the exhaust opening 13 is formed at one end of the rotary sintering furnace 10 in the axial direction of the rotary sintering furnace 10 (such as a front-rear direction as shown in FIG. 1), and the discharge outlet and the air inlet 12 are formed at one end of the rotary sintering furnace 10 in the axial direction of the rotary sintering furnace 10. The feed inlet 14 is configured to introduce the materials into the furnace cavity 11. The materials are introduced into the furnace cavity 11 from the feed inlet 14 and react in the furnace cavity 11 with rotation of the furnace cavity 11, and then leave the furnace cavity 11 from the discharge outlet. The protection gas is introduced into the furnace cavity 11 from the air inlet 12. The impurities carried by the materials in the furnace cavity 11 are discharged from the furnace cavity 11 through the exhaust opening 13 along with the protection gas inside the furnace cavity 11 to form the exhaust gas.

In the related art, the materials introduced into the furnace cavity may contain more moisture and oil, easily leading to a serious adhesion problem of materials on an inner wall at a feed inlet end of the rotary sintering furnace. After the materials are bonded, a too high local temperature is easily caused, resulting in over-sintering and skin formation of the materials, leading to material loss. Moreover, the too high temperature causes the material to react with the furnace body, resulting in metal precipitation, causing a magnetic substance content in the product to exceed the standard, affecting product performance.

However, in the present disclosure, by forming the feed inlet 14 and the exhaust opening 13 at one end of the rotary sintering furnace 10 in the axial direction of the rotary sintering furnace 10, and forming the discharge outlet and the air inlet 12 at one end of the rotary sintering furnace 10 in the axial direction of the rotary sintering furnace 10, impurities such as moisture and oil between the materials at the feed inlet 14 may be taken away by the exhaust gas, reducing a possibility of material adhesion on the inner wall of the rotary sintering furnace 10. Moreover, the protection gas is fed from a product discharge outlet end of the rotary sintering furnace 10 and flows towards a raw material input end, making the protection gas inside the rotary sintering furnace 10 sufficient, which is beneficial to ensuring the protection gas atmosphere inside the rotary sintering furnace 10. Moreover, it can be ensured that a protection gas atmosphere at the product discharge outlet end of the rotary sintering furnace 10 is more abundant. Moreover, an internal environment of the furnace chamber 11 is maintained in a positive pressure environment to avoid infiltration of the external gas from installation gaps of components, which is beneficial to control of an oxygen content of the internal gas atmosphere of the rotary sintering furnace 10, thereby effectively preventing the sintered product from being oxidized and causing product deterioration, and improving the product quality.

For example, in some specific embodiments, as shown in FIG. 1, the air inlet 12 and the discharge outlet are formed at a rear end of the rotary sintering furnace 10 in the axial direction of the rotary sintering furnace 10. The feed inlet 14 and the exhaust opening 13 are formed at a front end of the rotary sintering furnace 10 in the axial direction of the rotary sintering furnace 10. The materials flow from the front end to the rear end of the rotary sintering furnace 10. The protection gas flows from the rear end of the rotary sintering furnace to the front end. In this way, the impurities in the materials can be more fully taken away by the exhaust gas. Moreover, the furnace cavity 11 can be filled with the protection gas.

In some embodiments of the present disclosure, the sintering system 100 further includes the rapping device. The rapping device is configured to rap a second connection pipe 70, and two adjacent treatment devices are connected through the second connection pipe 70, reducing the adhesion and accumulation problems of the dust, the coal tar, and other impurities in the second connection pipe 70, improving a flow speed of exhaust gas between the two adjacent treatment devices, and improving the impurity removal efficiency.

In some embodiments, a polishing degree Ra of an inner wall of the second connection pipe 70 is smaller than or equal to 0.8 μm, making the inner wall of the second connection pipe 70 relatively smooth, which is beneficial to a reduction in an adhesion rate of the impurities of the exhaust gas in the second connection pipe 70 and a reduction in a possibility where the second connection pipe 70 is blocked since the impurities adhere to the wall. For example, the polishing degree Ra is 0.4 μm, 0.6 μm, or 0.8 μm. Especially for the lithium-ion battery cathode material, impurities are easily generated during the sintering of the lithium-ion battery cathode material, making the polishing degree Ra of the inner wall of the second connection pipe smaller than or equal to 0.8 μm, and having the better impurity removal effect on the exhaust gas during the exhaust gas treatment process.

Other arrangements and operations of the sintering system 10 according to the embodiments of the present disclosure are known to those of ordinary skill in the art, and the description thereof in detail will be omitted herein.

In the present disclosure, it should be noted that, unless otherwise clearly specified and limited, terms such as “install”, “connect”, “couple”, and the like should be understood in a broad sense. For example, it can be a fixed connection or a detachable connection or connection as one piece; a mechanical connection or an electrical connection; a direct connection or an indirect connection through an intermediate; or internal communication of two components. For those of ordinary skill in the art, the specific meaning of the above terms in the present disclosure should be understood according to specific circumstances.

In the description of this specification, descriptions of “embodiments”, “specific embodiments”, “examples”, etc., mean that specific features, structure, materials or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics can be combined in any one or more embodiments or examples in a suitable manner.

Although embodiments of the present disclosure have been illustrated and described, it is conceivable for those of ordinary skilled in the art that various changes, modifications, replacements, and variations can be made to these embodiments without departing from the principles and spirit of the present disclosure. The scope of the present disclosure shall be defined by the claims as appended and their equivalents.

What is claimed is:

1. A sintering system, comprising:
a rotary sintering furnace having an exhaust opening configured to discharge exhaust gas; and
an exhaust gas treatment system connected to the exhaust opening and configured to treat the exhaust gas discharged from the rotary sintering furnace, the exhaust gas treatment system comprising multi-stage treatment devices connected in series, wherein:
at least one stage of the multi-stage treatment devices is a dust separation device, the dust separation device being configured to separate dust from the exhaust gas; and
at least one stage of the multi-stage treatment devices is a spray tower disposed downstream of the dust separation device, the spray tower being configured to wash the exhaust gas that has been treated by the dust separation device.

2. The sintering system according to claim 1, wherein the dust separation device comprises a settling tank, the settling tank comprising a tank body and a plurality of baffles disposed in the tank body, and the tank body having a first inlet and a first outlet, wherein:
the plurality of baffles extend in a vertical direction or in an obliquely downward direction, wherein in a horizontal direction, the plurality of baffles are arranged in a staggered manner at intervals and divide a space in the tank body into a plurality of sub-spaces arranged in the horizontal direction, two sub-spaces of the plurality of sub-spaces located at two ends of the plurality of sub-spaces in the horizontal direction being connected to the first inlet and the first outlet, respectively; and
each of the plurality of baffles has a communication opening, two sub-spaces of the plurality of sub-spaces adjacent to the baffle being connected to each other through the communication opening, and projections of communication openings of any two adjacent baffles of the plurality of baffles in an arrangement direction of the plurality of baffles being non-overlapping.

3. The sintering system according to claim 2, wherein the settling tank further has a dust exhaust opening located at a bottom of the settling tank, each of the plurality of sub-spaces being connected to the dust exhaust opening.

4. The sintering system according to claim 3, wherein the tank body has a flow guide cavity and a dust collection cavity connected to the flow guide cavity, the flow guide cavity being located above the dust collection cavity, cross-sectional areas of the dust collection cavity on a horizontal plane gradually decreasing away from the flow guide cavity, and the dust exhaust opening being connected to the dust collection cavity.

5. The sintering system according to claim 1, wherein the dust separation device comprises a three-way pipe, a buffer tank, and a cyclone separator, wherein the three-way pipe comprises a first pipe body, a second pipe body, and a third pipe body, wherein:
the first pipe body has an air inlet end connected to the exhaust opening;
the first pipe body has an air outlet end connected to an air inlet end of the second pipe body and an air inlet end of the third pipe body;
the second pipe body has an air outlet end connected to the cyclone separator;
the third pipe body has an air outlet end connected to the buffer tank;
the air inlet end of the first pipe body is higher than or equal to the air outlet end of the first pipe body in a vertical direction;
the air outlet end of the third pipe body is lower than the air inlet end of the third pipe body in the vertical direction; and
an angle between the first pipe body and the second pipe body is a, an angle between the second pipe body and a vertically downward direction is b, and an angle between the third pipe body and the vertically downward direction is c, where a≥90°, b>0°, c≤b.

6. The sintering system according to claim 1, wherein the dust separation device comprises a three-way pipe, a buffer tank, and a cyclone separator, wherein the three-way pipe comprises a first pipe body, a second pipe body, and a third pipe body, wherein:
the first pipe body has an air inlet end connected to the exhaust opening;
the first pipe body has an air outlet end connected to an air inlet end of the second pipe body and an air inlet end of the third pipe body;
the second pipe body has an air outlet end connected to the cyclone separator;
the third pipe body has an air outlet end connected to the buffer tank;
each of the first pipe body and the third pipe body extends in a vertical direction; and
the second pipe body extends in a horizontal direction.

7. The sintering system according to claim 5, wherein:
the buffer tank has a first opening formed at a top of the buffer tank and a second opening formed at a bottom of the buffer tank, the first opening being connected to the three-way pipe, and the second opening being configured to discharge sediment;
the cyclone separator has a third opening and a fourth opening that are formed at a top of the cyclone separator and a fifth opening formed at a bottom of the cyclone separator, the third opening being connected to the three-way pipe, the fourth opening being connected to a downstream treatment device of the multi-stage treatment devices, and the fifth opening being configured to discharge the sediment; and
an on-off valve is disposed at each of the second opening and the fifth opening.

8. The sintering system according to claim 6, wherein:
the buffer tank has a first opening formed at a top of the buffer tank and a second opening formed at a bottom of the buffer tank, the first opening being connected to the three-way pipe, and the second opening being configured to discharge sediment;
the cyclone separator has a third opening and a fourth opening that are formed at a top of the cyclone separator and a fifth opening formed at a bottom of the cyclone separator, the third opening being connected to the three-way pipe, the fourth opening being connected to a downstream treatment device of the multi-stage treatment devices, and the fifth opening being configured to discharge the sediment; and
an on-off valve is disposed at each of the second opening and the fifth opening.

9. The sintering system according to claim 1, wherein the spray tower comprises a tower body, a spray assembly, a liquid redistributor, and a demister, wherein:
the tower body has a second inlet formed at a side of the tower body and a second outlet formed at a top of the tower body;
the spray assembly comprises a spray head disposed in the tower body and located between the second inlet and the second outlet;
the liquid redistributor is located between the spray head and the second inlet; and
the demister is located between the spray head and the second outlet.

10. The sintering system according to claim 9, wherein a plurality of spray heads are provided and arranged in a plurality of layers in a vertical direction, the liquid redistributor being provided for each of the plurality of layers of spray heads and located below the spray head, and the demister being disposed above the plurality of layers of spray heads.

11. The sintering system according to claim 1, wherein the exhaust gas treatment system is further connected in series with an induced draft fan, the induced draft fan being configured to drive the exhaust gas to flow in the exhaust gas treatment system.

12. The sintering system according to claim 1, wherein the exhaust gas treatment system is connected to the exhaust opening through a first connection pipe, heights of the first connection pipe in a vertical direction increasing and then decreasing from an end of the first connection pipe to another end of the first connection pipe.

13. The sintering system according to claim 12, wherein the first connection pipe comprises a first pipe segment and a second pipe segment, wherein:
the exhaust opening is connected to the second pipe segment through the first pipe segment;
the first pipe segment is connected to the exhaust gas treatment system through the second pipe segment;
the first pipe segment and the second pipe segment extend downwards and away from each other from a connection between the first pipe segment and the second pipe segment; and
an angle between the first pipe segment and the second pipe segment is greater than or equal to 60°.

14. The sintering system according to claim 12, wherein at least one of the exhaust opening and the exhaust gas treatment system is connected to the first connection pipe through a flexible pipe.

15. The sintering system according to claim 13, wherein at least one of the exhaust opening and the exhaust gas treatment system is connected to the first connection pipe through a flexible pipe.

16. The sintering system according to claim 12, wherein:
a polishing degree Ra of the first connection pipe is smaller than or equal to 0.8 μm; and/or
a polishing degree Ra of an inner wall surface of each of the multi-stage treatment devices is smaller than or equal to 0.8 μm.

17. The sintering system according to claim 1, wherein:
the rotary sintering furnace has a furnace cavity, an air inlet, and the exhaust opening, the air inlet and the exhaust opening being connected to the furnace cavity, the air inlet being configured to introduce a protection gas into the furnace cavity, and the exhaust opening being configured to discharge the exhaust gas from the furnace cavity; and
the rotary sintering furnace has a feed inlet and a discharge outlet that are respectively formed at two ends of the rotary sintering furnace in an axial direction of the rotary sintering furnace, each of the feed inlet and the discharge outlet being connected to the furnace cavity, the feed inlet and the exhaust opening being formed at one end of the rotary sintering furnace in the axial direction of the rotary sintering furnace, and the discharge outlet and the air inlet being formed at one end of the rotary sintering furnace in the axial direction of the rotary sintering furnace.

18. The sintering system according to claim 1, further comprising a rapping device, wherein:
the rapping device is configured to rap the multi-stage treatment devices; and/or
the rapping device is configured to rap a first connection pipe, the exhaust gas treatment system being connected to the exhaust opening through the first connection pipe; and/or
the rapping device is configured to rap a second connection pipe, two adjacent treatment devices of the multi-stage treatment devices being connected through the second connection pipe.

19. The sintering system according to claim 12, wherein a thermal insulation structure is disposed outside the first connection pipe and/or the dust separation device.

20. The sintering system according to claim 1, wherein the sintering system is applied in preparation of new energy materials to perform dynamical sintering on raw materials, the new energy materials comprising a lithium-ion battery cathode material, and the lithium-ion battery cathode material comprising one of lithium iron phosphate, lithium cobalt oxide, and lithium nickel cobalt manganese oxide.
